(19) United States
(12) Patent Application Publication
(10) Pub. No.: US 2007/0138940 A1
(43) Pub. Date: Jun. 21, 2007

(54) Surface electron emission device and display device having the same

(75) Inventors: Chang-wook Moon, Seoul (KR); Sang-mock Lee, Yongin-si (KR); El Mostafa Bourim, Yongin-si (KR); Seung-woon Lee, Yongin-si (KR); Eun-hong Lee, Anyang-si (KR); Choong-rae Cho, Gimhae-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/543,848

(22) Filed: Oct. 6, 2006

(30) Foreign Application Priority Data
Dec. 21, 2005 (KR) 10-2005-0126912

(51) Int. Cl. H01J 63/04; H01J 1/62

(52) U.S. Cl. 313/496

(57) ABSTRACT

Provided are a surface electron emission device and a display device having the same. The surface electron emission device may include a lower electrode, an insulating layer, and an upper electrode sequentially stacked, and a nano structure layer formed on the upper electrode.

### PRIORITY STATEMENT

This application claims the benefit of priority under 35 U.S.C. §119 to Korean Patent Application No. 10-2005-0126912, filed on Dec. 21, 2005, in the Korean Intellectual Property Office (KIPO), the entire contents of which are incorporated herein by reference.

### BACKGROUND

1. Field

Example embodiments relate to a surface electron emission device and a display device having the same. Other example embodiments relate to a surface electron emission device having a metal-insulator-metal-insulator-metal (MIMIM) structure and a display device having the same.

2. Description of the Related Art

Generally, a field emission display may emit light by exciting a phosphor layer on an anode electrode to which was applied about a few tens kV using electrons emitted from an emitter. In the field emission display, to reduce sparking between the anode electrode and the emitter, a gap between the anode electrode and a cathode electrode, where the emitter is located, may be widened, for example, about 1 mm to about 3 mm, thereby increasing the size of the field emission display.

A simple electron emission device that reduces a voltage applied to the anode electrode may have a metal-insulator-metal (MIM) structure corresponding to the cathode electrode. The MIM device may include an insulating layer between an upper electrode and a lower electrode. When a given voltage is applied between the upper electrode and the lower electrode, a relatively high electric field may be induced in the insulating layer. Electrons emitted from the lower electrode may be transmitted to the upper electrode through the insulating layer and the electrons may be discharged to the outside through the upper electrode. The electrons emitted from a surface of the upper electrode may be called surface electrons and/or hot electrons. To increase the emission efficiency of the surface electrons, the insulating layer must be relatively thin, and also, a work function of the upper electrode may be reduced by reducing the thickness of the upper electrode.

However, the insulating layer may be damaged when a voltage of a few tens V is applied between the upper electrode and the lower electrode, and also, the lifetime of the upper electrode may be reduced. A conventional light emitting device having a metal-insulator-metal-insulator-metal (MIMIM) structure may have the same problem as the MIM structure.

### SUMMARY

Example embodiments relate to a surface electron emission device and a display device having the same. Other example embodiments relate to a surface electron emission device having a metal-insulator-metal-insulator-metal (MIMIM) structure and a display device having the same.

According to example embodiments, a surface electron emission device may include a lower electrode, at least one insulating layer, and an upper electrode sequentially stacked and a nano structure layer formed on the upper electrode. The nano structure layer may be a carbon nano structure layer and the carbon nano structure layer may be a fullerene layer. The nano structure layer may be formed to a thickness of about 0.2 nm to about 20 nm. The at least one insulating layer may be one selected from the group consisting of an Al₂O₃ layer, a NiO layer, a ZrO₂ layer, a ZnO layer and/or a TiO₂ layer. At least one of the lower electrode and the upper electrode may be one selected from the group consisting of an Au layer, a Cu layer, an Al layer, a Nb layer, an Ag layer, a W layer, a Co layer and/or a Ni layer.

According to other example embodiments, the at least one insulating layer may include two insulating layers. The surface electron emission device may further include an intermediate electrode between the two insulating layers. The intermediate electrode may be may be one selected from the group consisting of an Au layer, a Cu layer, an Al layer, a Nb layer, an Ag layer, a W layer, a Co layer and/or a Ni layer.

According to other example embodiments, a display device having a surface electron emission device may include an upper substrate and a lower substrate parallel to each other, an anode electrode formed an inner side of the upper substrate facing the lower substrate, a phosphor layer formed on the anode electrode and a surface electron emission device according to example embodiments formed on the lower substrate. The lower electrode and the upper electrode may be stripe shaped electrodes that form one pixel region where they cross each other. The upper electrode and the upper substrate may be formed of a transparent material so that light can pass through.

### BRIEF DESCRIPTION OF THE DRAWINGS

The example embodiments will be more clearly understood from the following detailed description taken in conjunction with the accompanying drawings. FIGS. 1-25 represent non-limiting, the example embodiments as described herein.

FIGS. 1 and 3 are diagrams illustrating a metal-insulator-metal (MIM) device according to example embodiments; and

FIGS. 2 and 4 are diagrams illustrating a display device having a MIM device according to example embodiments.

### DETAILED DESCRIPTION OF EXAMPLE EMBODIMENTS

A surface electron emission device (hereinafter, a MIM device) having a metal-insulator-metal (MIM) structure and a surface electron emission device (hereinafter, MIMIM device) having a metal-insulator-metal-insulator-metal (MIMIM) structure according to example embodiments and a display device having the same will now be described more fully with reference to the accompanying drawings in which example embodiments are shown. Example embodiments may, however, be embodied in many different forms and should not be construed as limited to the embodiments set forth herein. Rather, the embodiments are provided so that disclosure of the example embodiments will be thorough and complete, and will fully convey the scope of example embodiments to those skilled in the art. The principles and features of example embodiments may be employed in varied and numerous embodiments without departing from the scope of example embodiments. In the drawings, the thicknesses of layers and regions are exaggerated for clarity. Like reference numerals designate like elements throughout the drawings.

It will also be understood that when an element or layer is referred to as being “on,” “connected to” and/or “coupled to” another element or layer, the element or layer may be directly on, connected and/or coupled to the other element or layer or intervening elements or layers may be present. In contrast, when an element is referred to as being “directly on,” “directly connected to” and/or “directly coupled to” another element or layer, no intervening elements or layers are present. As used herein, the term “and/or” may include any and all combinations of one or more of the associated listed items.

It will also be understood that, although the terms first, second, etc. may be used herein to describe various elements, components, regions, layers and/or sections. These elements, components, regions, layers and/or sections should not be limited by these terms. These terms may be used to distinguish one element, component, region, layer and/or section from another element, component, region, layer and/or section. For example, a first element, component, region, layer and/or section discussed below could be termed a second element, component, region, layer and/or section without departing from the teachings of example embodiments.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (rotated 90 degrees or at other orientations) and the spatially relative descriptors used herein interpreted accordingly.

The terminology used herein is for the purpose of describing particular embodiments only and is not intended to limit the example embodiments. As used herein, the singular terms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized and/or overly formal sense unless expressly so defined herein.

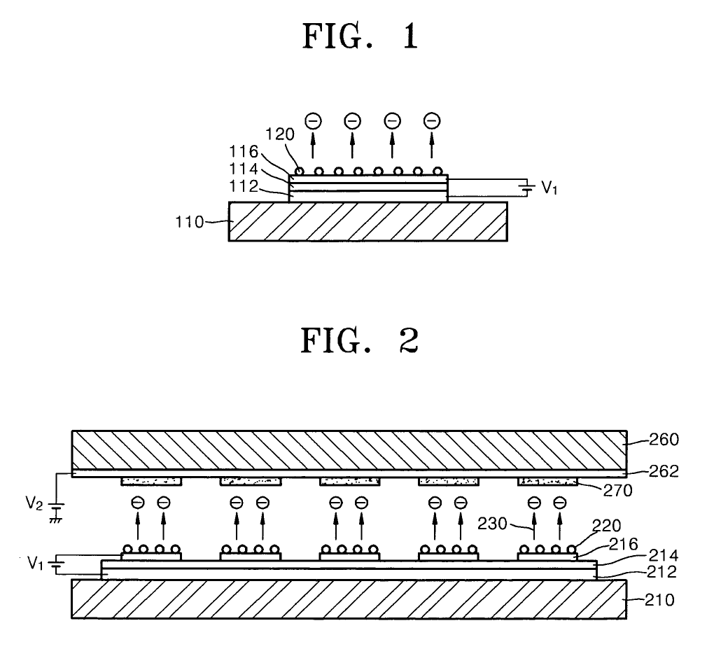

FIG. 1 is a diagram illustrating a MIM device according to example embodiments. Referring to FIG. 1, a MIM device may be formed on a substrate 110. The MIM device may include a lower electrode 112, an insulating layer 114, and an upper electrode 116 sequentially formed on the substrate 110 and a fullerene layer 120 formed on the upper electrode 116. The lower electrode 112 may be formed of a conductive material, for example, aluminum. The lower electrode 112 may be formed to a thickness of a few hundreds of nm.

The insulating layer 114 may be an aluminum oxide layer, for example, an Al₂O₃ layer and/or another insulating layer, for example, a NiO layer, a ZrO₂ layer, a ZnO layer and/or a TiO₂ layer. When the insulating layer 114 is an Al₂O₃ layer, the insulating layer 114 may have a thickness of about 2 nm to about 20 nm. The thickness of the insulating layer 114 may vary according to the material used to form the insulating layer 114. The upper electrode 116 may be formed of a material having a relatively low work function, for example, Au, to a thickness of about 10 nm to about 30 nm. The upper electrode 116 may be formed of materials other than Au, for example, Cu, Al, Nb, Ag, W, Co and/or Ni.

The fullerene layer 120 may be, for example, a carbon nano structure layer. The fullerene layer 120 may be replaced by another carbon nano structure layer and/or a different nano structure layer. The fullerene layer 120 may be a coating of given fullerene molecules. The fullerene molecules may be C₆₀ and/or may be a fullerene molecule family other than C₆₀, for example, C₇₀, C₇₂, C₇₄, C₇₆, C₈₂, C₈₄, C₈₆ and/or C₁₁₆. The fullerene layer 120 may be formed to a thickness of about 0.2 nm to about 20 nm.

After the MIM device is placed in a vacuum chamber maintained at a vacuum of 10⁻⁴ to 10⁻⁵ Torr, a positive voltage may be applied to the upper electrode 116 and a negative voltage may be applied to the lower electrode 112 so that a voltage V₁ between the upper electrode 116 and the lower electrode 112 may be about 2V to about 25V. Electrons may be emitted from the lower electrode 112 and may be migrated to the upper electrode 116 through the insulating layer 114 by means of a tunnelling effect. If the electrons have an energy greater than the work function of the upper electrode 116, the electrons may be emitted away from a surface of the upper electrode 116. The electrons emitted from the surface of the upper electrode 116 may be referred to as surface electrons and/or hot electrons. The voltage V₁ may be determined according to the material and thickness of the insulating layer 114 and the work function of the upper electrode 116.

The fullerene layer 120 may reduce the work function of the upper electrode 116. Accordingly, a voltage lower than a voltage applied to a conventional MIM device may be applied to the MIM device according to example embodiments. Also, the fullerene layer 120 may reduce damage to the upper electrode 116 because the fullerene layer 120 may have a relatively high tensile strength.

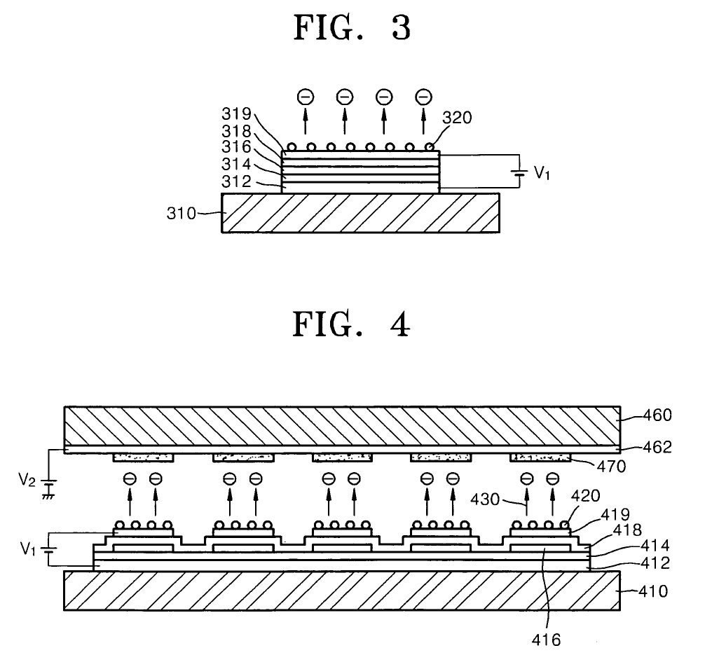

FIG. 2 is a diagram illustrating a display device having a metal-insulator-metal (MIM) device according to example embodiments. The same names may be used for substantially identical components in the MIM device of FIG. 1 and the MIM device of FIG. 2, and thus detailed descriptions thereof are omitted.

Referring to FIG. 2, the MIM device may be formed on a lower substrate 210. An anode electrode 262 and a phosphor layer 270 may be formed on an upper substrate 260. The anode electrode 262 and the upper substrate 260 may be a transparent electrode and a glass substrate, respectively, so that light may pass through. An inner space of the display device in FIG. 2 may be maintained at a pressure of about 10⁻⁴ Torr to about 10⁻⁵ Torr. A gap between the lower substrate 210 and the upper substrate 260 may be maintained at about 0.5 mm. The MIM device may include a lower electrode 212, an insulating layer 214, an upper electrode 216 sequentially formed on the lower substrate 210, and a fullerene layer 220 formed on the upper electrode 216. The lower electrode 212 may be formed of a conductive material, for example, aluminum to a thickness of about a few hundreds of nm.

The insulating layer 214 may be an aluminum oxide layer, for example, an Al₂O₃ layer and/or another insulating layer, for example, a NiO layer, a ZrO₂ layer, a ZnO layer and/or a TiO₂ layer. When the insulating layer 214 is an Al₂O₃ layer, the insulating layer 214 may have a thickness of about 2 nm to about 20 nm. The thickness of the insulating layer 214 may vary according to the material used to form the insulating layer 214. The upper electrode 216 may be formed of a material having a relatively low work function, for example, gold (Au) to a thickness of about 10 nm to about 30 nm. The upper electrode 216 may be formed of materials other than Au, for example, Cu, Al, Nb, Ag, W, Co and/or Ni.

The fullerene layer 220 may be, for example, a carbon nano structure layer. The fullerene layer 220 may be replaced by another carbon nano structure layer and/or a different nano structure layer. The fullerene layer 220 may be a coating of given fullerene molecules. The fullerene molecules may be C₆₀ and/or may be a fullerene molecule family other than C₆₀, for example, C₇₀, C₇₄, C₇₆, C₇₂, C₈₂, C₈₄, C₈₆ and/or C₁₁₆. The fullerene layer 220 may be formed to a thickness of about 0.2 nm to about 20 nm.

A positive voltage may be applied to the upper electrode 216 and a negative voltage may be applied to the lower electrode 212 so that a voltage V1 between the upper electrode 216 and the lower electrode 212 may be about 2V to about 25V. Electrons may be emitted from the lower electrode 212 and may be migrated to the upper electrode 216 through the insulating layer 214. Surface electrons 230 may be emitted from a surface of the upper electrode 216. When a given voltage V2, for example, a ground voltage and/or a positive voltage of about a few to a few tens of volts is applied to the anode electrode 262, the surface electrons 230 may proceed toward the anode electrode 262 exciting the phosphor layer 270 to emit light.

The upper electrode 216 and the lower electrode 212 may be stripe shaped electrodes that cross each other. When the upper electrode 216 and the lower electrode 212 are addressed, surface electrons 230 may be emitted from an addressed portion of the upper electrode 216 and may excite the adjacent phosphor layer 270. When widths of the upper electrode 216 and the lower electrode 212 and an area of the phosphor layer 270 are formed corresponding to one pixel and/or red R, green G, and blue B sub-pixels, the display device of FIG. 2 may display an image. The phosphor layer 270 that corresponds to the one pixel and/or red R, green G, and blue B sub-pixels may be divided by a black matrix (not shown).

The display device according to example embodiments may be operated even though the display device is packaged to a relatively low degree of vacuum. Also, a gap of about 0.5 mm may be maintained between the upper substrate 260 and the lower substrate 210 because the voltage applied to the anode electrode 262 may be relatively low, for example, no sparking may occur between the upper substrate 260 and the lower substrate 210.

FIG. 3 is a diagram illustrating a metal-insulator-metal-insulator-metal (MIMIM) device according to other example embodiments. Referring to FIG. 3, the MIMIM device may be formed on a lower substrate 310. The MIMIM device may include a lower electrode 312, a first insulating layer 314, an intermediate electrode 316, a second insulating layer 318, an upper electrode 319 sequentially formed on the lower substrate 310, and a fullerene layer 320 formed on the upper electrode 319.

The lower electrode 312 may be formed of a conductive material, for example, aluminum to a thickness of about a few hundreds of nm. The first and second insulating layers 314 and 318 may be aluminum oxide layers, for example, Al₂O₃ layers and/or other insulating layers, for example, NiO layers, ZrO₂ layers, ZnO layers and/or TiO₂ layers. When the first and second insulating layers 314 and 318 are Al₂O₃ layers, the first and second insulating layers 314 and 318 may have a thickness of about 2 nm to about 20 nm. The thickness of the first and second insulating layers 314 and 318 may vary according to the material used to form the first and second insulating layers 314 and 318.

The intermediate electrode 316 may be formed of a material having a relatively low work function to a thickness of about 10 nm to about 30 nm. The intermediate electrode 316 may be formed of Al, Au, Cu, Nb, Ag, W, Co and/or Ni. The upper electrode 319 may be formed of a material having a relatively low work function, for example, Au to a thickness of about 10 nm to about 30 nm. The upper electrode 319 may be formed of materials other than Au, for example, Cu, Al, Nb, Ag, W, Co and/or Ni. The fullerene layer 320 may be, for example, a carbon nano structure layer. The fullerene layer 320 may be replaced by another carbon nano structure layer and/or a different nano structure layer. The fullerene layer 320 may be a coating of given fullerene molecules. The fullerene molecules may be C₆₀ and/or may be a fullerene molecule family other than C₆₀, for example, C₇₀, C₇₂, C₇₄, C₇₆, C₈₂, C₈₄, C₈₆ and/or C₁₁₆. The fullerene layer 320 may be formed to a thickness of about 0.2 nm to about 20 nm.

After the MIMIM device is placed in a vacuum chamber maintained at a vacuum of about 10⁻⁴ Torr to about 10⁻⁵ Torr, a positive voltage may be applied to the upper electrode 319 and a negative voltage may be applied to the lower electrode 312 so that a voltage V₁ between the upper electrode 319 and the lower electrode 312 may be about 2V to about 25V. Electrons may be emitted from the lower electrode 312 and may be migrated to the upper electrode 319 through the first insulating layer 314, the intermediate electrode 316, and the second insulating layer 318. Surface electrons may be emitted from a surface of the upper electrode 319. The electrons emitted from the surface of the upper electrode 319 may be referred to as surface electrons and/or hot electrons. The voltage V₁ may be determined according to the material and thickness of the first and second insulating layers 314 and 318 and the work function of the upper electrode 319.

The fullerene layer 320 may reduce the work function of the upper electrode 319. Accordingly, a voltage lower than a voltage applied to a conventional MIM device may be applied to the MIMIM device according to example embodiments. Also, the fullerene layer 320 may reduce damage to the upper electrode 319.

FIG. 4 is a diagram illustrating a display device having a MIMIM device according to other example embodiments. The same names may be used for substantially identical components in the MIMIM device of FIG. 3 and the MIMIM device of FIG. 4, and thus detailed descriptions thereof are omitted.

Referring to FIG. 4, the MIMIM device may be formed on a lower substrate 410. An anode electrode 462 and a phosphor layer 470 may be formed on an upper substrate 460. The anode electrode 462 and the upper substrate 460 may be a transparent electrode and a glass substrate, respectively, so that light may pass through. An inner space of the display device in FIG. 4 may be maintained at a pressure of about 10⁻⁴ Torr to about 10⁻⁵ Torr. A gap between the lower substrate 410 and the upper substrate 460 may be maintained at about 0.5 mm.

The MIMIM device may include a lower electrode 412, a first insulating layer 414, an intermediate electrode 416, a second insulating layer 418, an upper electrode 419 sequentially formed on the lower substrate 410, and a fullerene layer 420 formed on the upper electrode 419. The lower electrode 412 may be formed of a conductive material, for example, aluminum to a thickness of about a few hundreds of nm.

The first and second insulating layers 414 and 418 may be aluminum oxide layers, for example, Al₂O₃ layers and/or other insulating layers, for example, NiO layers, ZrO₂ layers, ZnO layers and/or TiO₂ layers. When the first and second insulating layers 414 and 418 are Al₂O₃ layers, the first and second insulating layers 414 and 418 may have a thickness of about 2 nm to about 20 nm. The thickness of the first and second insulating layers 414 and 418 may vary according to the material used to form the first and second insulating layers 414 and 418.

The intermediate electrode 416 may be formed of a material having a relatively low work function to a thickness of about 10 nm to about 30 nm. The intermediate electrode 416 may be formed of Al, Au, Cu, Nb, Ag, W, Co, Ni and/or any other suitable element. The intermediate electrode 416 may be formed in a stripe shape like the upper electrode 419. The upper electrode 419 may be formed of a material having a relatively low work function, for example, Au to a thickness of about 10 nm to about 30 nm. The upper electrode 419 may be formed of materials other than Au, for example, Cu, Al, Nb, Ag, W, Co and/or Ni.

The fullerene layer 420 may be, for example, a carbon nano structure layer. The fullerene layer 420 may be replaced by another carbon nano structure layer and/or a different nano structure layer. The fullerene layer 420 may be a coating of given fullerene molecules. The fullerene molecules may be C₆₀ and/or may be a fullerene molecule family other than C₆₀, for example, C₇₀, C₇₄, C₇₆, C₇₂, C₈₂, C₈₄, C₈₆ and/or C₁₁₆. The fullerene layer 420 may be formed to a thickness of about 0.2 nm to about 20 nm.

A positive voltage may be applied to the upper electrode 419 and a negative voltage may be applied to the lower electrode 412 so that a voltage V₁ between the upper electrode 419 and the lower electrode 412 may be about 2V to about 25V. Electrons may be emitted from the lower electrode 212 and may be migrated to the upper electrode 419 through the first and second insulating layers 414 and 418. Surface electrons 430 may be emitted from a surface of the upper electrode 419. When a given voltage V₂, for example, a ground voltage and/or a positive voltage of about a few to a few tens of volts is applied to the anode electrode 462, the surface electrons 430 may proceed toward the anode electrode 462 exciting the phosphor layer 470 to emit light.

The upper electrode 419 and the lower electrode 412 may be stripe shaped electrodes that cross each other. When the upper electrode 419 and the lower electrode 412 are addressed, surface electrons 430 may be emitted from an addressed portion of the upper electrode 419 and excite the adjacent phosphor layer 470. When widths of the upper electrode 419 and the lower electrode 412 and an area of the phosphor layer 470 are formed corresponding to one pixel and/or red R, green G, and blue B sub-pixels, the display device of FIG. 4 may display an image. The phosphor layer 470 that corresponds to the one pixel and/or red R, green G, and blue B sub-pixels may be divided by a black matrix (not shown).

The display device according to example embodiments may be operated although the display device is packaged to a relatively low degree of vacuum. Also, a gap of about 0.5 mm may be maintained between the upper substrate 460 and the lower substrate 410 because the voltage applied to the anode electrode 462 may be relatively low, for example, no sparking may occur between the upper substrate 260 and the lower substrate 410.

As described above, the MIM device and/or the MIMIM device according to example embodiments may include a fullerene layer having a relatively high tensile strength on the upper electrode. The fullerene layer may reduce the work function of the upper electrode to facilitate the emission of electrons from the upper electrode, and may protects the upper electrode from being damaged, thereby extending the lifetime of the upper electrode. According to example embodiments, the display device having the MIM device and/or the MIMIM device may be packaged to a relatively low degree of vacuum, thereby possibly reducing a gap between the upper substrate and the lower substrate.

While example embodiments have been particularly shown and described with reference to example embodiments thereof, it will be understood by those of ordinary skill in the art that various changes in form and details may be made therein without departing from the spirit and scope of the following claims.

What is claimed is:

1. A surface electron emission device comprising:
a lower electrode, at least one insulating layer, and an upper electrode sequentially stacked; and
a nano structure layer formed on the upper electrode.

2. The surface electron emission device of claim 1, wherein the nano structure layer is a carbon nano structure layer.

3. The surface electron emission device of claim 2, wherein the carbon nano structure layer is a fullerene layer.

4. The surface electron emission device of claim 1, wherein the nano structure layer is formed to a thickness of about 0.2 nm to about 20 nm.

5. The surface electron emission device of claim 1, wherein the at least one insulating layer is one selected from the group consisting of an aluminum oxide layer, a NiO layer, a ZrO₂ layer, a ZnO layer, and a TiO₂ layer.

6. The surface electron emission device of claim 1, wherein at least one of the lower electrode and the upper electrode is one selected from the group consisting of an Au layer, a Cu layer, an Al layer, a Nb layer, an Ag layer, a W layer, a Co layer, and a Ni layer.

7. The surface electron emission device of claim 1, wherein the at least one insulating layer includes two insulating layers.

8. The surface electron emission device of claim 7, further comprising:
an intermediate electrode between the two insulating layers.

9. The surface electron emission device of claim 8, wherein the nano structure layer is a carbon nano structure layer.

10. The surface electron emission device of claim 9, wherein the carbon nano structure layer is a fullerene layer.

11. The surface electron emission device of claim 8, wherein the nano structure layer is formed to a thickness of 0.2 to 20 nm.

12. The surface electron emission device of claim 8, wherein the two insulating layers are formed of one selected from the group consisting of aluminum oxide, NiO, ZrO₂, ZnO, and TiO₂.

13. The surface electron emission device of claim 8, wherein at least one of the lower electrode, the intermediate electrode, and the upper electrode is one selected from the group consisting of an Au layer, a Cu layer, an Al layer, a Nb layer, an Ag layer, a W layer, a Co layer, and a Ni layer.

14. A display device having a surface electron emission device, comprising:
an upper substrate and a lower substrate disposed parallel to each other;
an anode electrode formed on an inner surface of the upper substrate facing the lower substrate;
a phosphor layer formed on the anode electrode; and
the surface electron emission device of claim 1 formed on the lower substrate.

15. The display device of claim 14, wherein the lower electrode and the upper electrode are stripe shaped electrodes that form one pixel region where they cross each other.

16. The display device of claim 14, wherein the upper electrode and the upper substrate are formed of a transparent material so that light can pass through.

17. A display device having a surface electron emission device, comprising:
an upper substrate and a lower substrate disposed parallel to each other;
an anode electrode formed on an inner surface of the upper substrate facing the lower substrate;
a phosphor layer formed on the anode electrode; and
the surface electron emission device of claim 8 formed on the lower substrate.

18. The display device of claim 17, wherein the lower electrode and the upper electrode are stripe shaped electrodes that form one pixel region where they cross each other.

19. The display device of claim 17, wherein the upper electrode and the upper substrate are formed of a transparent material so that light can pass through.
